(19) United States
(12) Patent Application Publication
(10) Pub. No.: US 2007/0229780 A1
(43) Pub. Date: Oct. 4, 2007

(54) PROJECTION APPARATUS

(75) Inventors: CHEN-YI YANG, MIAO-LI COUNTY (TW); PO-HSIANG HUANG, MIAO-LI COUNTY (TW); CHENG-YANG CHEN, MIAO-LI COUNTY (TW)

Correspondence Address: J C PATENTS, INC., 4 VENTURE, SUITE 250, IRVINE, CA, 92618, US

(73) Assignee: CORETRONIC CORPORATION, MIAO-LI COUNTY (TW)

(21) Appl. No.: 11/616,642

(22) Filed: Dec. 27, 2006

(30) Foreign Application Priority Data
Mar. 29, 2006 (TW) 95110856

(51) Int. Cl. G03B 21/22

(52) U.S. Cl. 353/119

(57) ABSTRACT

A projection apparatus comprising a projection module, a driver module, a power circuitry and a casing is provided. The driver module is electrically connected to the projection module. The power circuitry is electrically connected to the driver module and has a first port for connecting to a universal serial bus (USB) port of a computer through a transmission cable. The casing encloses the projection module, the driver module and the power circuitry but exposes a portion of the first port. The projection apparatus is electrically connected to the USB port of the computer, and the power of the projection apparatus is provided through the computer so that an adapter is no longer required. Therefore, the projection apparatus is more convenient to users.

### CROSS-REFERENCE TO RELATED APPLICATION

This application claims the priority benefit of Taiwan application serial no. 95110856, filed Mar. 29, 2006. All disclosure of the Taiwan application is incorporated herein by reference.

### BACKGROUND OF THE INVENTION

1. Field of the Invention

The present invention relates to a projection apparatus. More particularly, the present invention relates to a projection apparatus operated by power provided by a computer.

2. Description of Related Art

To be portable, most projectors currently in the market are designed to occupy as little area as possible. The most compact and lightest projectors have a length and width even less than an A4 size paper. This type of projector has low power consumption. Furthermore, to facilitate operation, a re-chargeable battery is normally installed inside the apparatus for supplying the required power. Thus, even when the projector is brought outside to a remote location far away from any power plug, the built-in re-chargeable battery can still provide the power required to operate the projector. In other words, the projector can be conveniently used almost everywhere.

FIG. 1 is a block diagram showing the connection between a conventional projector and a computer. As shown in FIG. 1, the projection apparatus 30 is electrically connected to a computer 50 through a signal transmission cable 32 for receiving image signals from the computer 50. Then, according to the image signals, corresponding image light beams are produced and projected to display an image onto a screen. A re-chargeable battery is installed inside the projection apparatus 30 to provide the power required to operate the projection apparatus 30.

Although the projection apparatus 30 receives the power from the re-chargeable battery, an adapter 34 connected to a power socket 60 is still required when the power stored within the re-chargeable battery is low. The adapter converts the AC power in the power socket 60 into DC power to provide the required power for operating the projection apparatus 30 and charge up the re-chargeable battery inside the projection apparatus 30.

However, to prevent the electrical power stored inside the re-chargeable battery from dropping too low and causing the projection apparatus 30 to stop functioning, the user has to carry the adapter 34 at all times. The adapter not only increases the load a user has to carry, but the bulkiness of the adapter also occupies storage space as well. In addition, when the re-chargeable battery has insufficient power to drive the projection apparatus 300, the adapter 34 is useless in places where power outlet is unavailable. Moreover, additional power is consumed when power from a power socket is converted through the adapter 34 into useful power for driving the projection apparatus 30 and thus leads to power wastage. Furthermore, the provision of an adapter also incurs additional cost.

### SUMMARY OF THE INVENTION

Accordingly, at least one objective of the present invention is to provide a projection apparatus capable of receiving the required power from a computer.

To achieve these and other advantages and in accordance with the purpose of the invention, as embodied and broadly described herein, the invention provides a projection apparatus. The projection apparatus is suitable for connecting to at least a universal serial bus (USB) port of a computer so that the computer can provide the power required to operate the projection apparatus. The projection apparatus includes a projection module, a driver module, a power circuitry and a casing. The projection module is suitable for projecting an image light beam to display an image onto a screen. The driver module is electrically connected to the projection module. Furthermore, the driver module is suitable for driving the projection module. The power circuitry is electrically connected to the driver module. The power circuitry has a first port suitable for connecting to the USB port of the computer through a transmission cable. The casing encloses the projection module, the driver module and the power circuitry but exposes a portion of the first port.

In one embodiment of the present invention, the foregoing projection apparatus further includes a charger and a re-chargeable battery. The charger is disposed inside the casing and electrically connected to the power circuitry. The re-chargeable battery is also disposed inside the casing and electrically connected to the charger and the power circuitry. In addition, when the power circuitry is electrically connected to the computer through the first port, the charger is suitable for charging the re-chargeable battery. When the power circuitry is electrically insulated from the computer, the rechargeable battery is suitable for providing electric power to the power circuitry.

In one embodiment of the present invention, the foregoing projection apparatus further includes a charger, a second port and a re-chargeable battery. The charger is disposed inside the casing and electrically connected to the power circuitry. The second port is electrically connected to the power circuitry and the charger. The casing exposes a portion of the second port. The re-chargeable battery is disposed outside the casing and is suitable for electrically connecting to the charger and the power circuitry through the second port. In addition, when the power circuitry is electrically connected to the computer through the first port, the charger is suitable for charging the re-chargeable battery. On the other hand, when the power circuitry is electrically insulated from the computer, the re-chargeable battery is suitable for providing electric power to the power circuitry.

In one embodiment of the present invention, the foregoing projection module includes a light source, a light valve and a projection lens for providing an illumination light beam. The light valve is disposed on the transmission path of the illumination light beam so that the illumination light beam is converted into an image light beam. The projection lens is disposed on the transmission path of the image light beam for projecting the image light beam to display an image onto the screen.

In one embodiment of the present invention, the foregoing light source is a light-emitting diode (LED), for example.

The projection apparatus of the present invention utilizes the special capacity of the USB port of a computer to provide the power for operating a projection apparatus through the computer. When it is a need to output computer image signal through the projection apparatus, but the power of the battery inside the projection apparatus is low, the computer can directly provide the power required to operate the projection apparatus. With this arrangement, there is no need to use an adapter so that the cost of producing the adapter is saved.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram showing the connection between a conventional projector and a computer.

FIG. 2 is a block diagram showing the connection between a projection apparatus and a computer according to one embodiment of the present invention.

FIG. 3 is a block diagram showing the projection apparatus shown in FIG. 2.

FIG. 4 is a block diagram showing a projection apparatus according to another embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 2 is a block diagram showing the connection between a projection apparatus and a computer according to one embodiment of the present invention. As shown in FIG. 2, the projection apparatus 100 in the present embodiment is electrically connected to a computer 50 through a signal transmission cable 102 for receiving image signals from the computer 50. Next, according to the image signals, a corresponding image light beam is produced and projected to display an image onto a screen (not shown). In addition, the projection apparatus 100 is electrically connected to a universal serial bus (USB) port of the computer 50 through a USB transmission cable 200 so that the computer 50 provides the power required to operate the projection apparatus 100. In the following, a more detailed description of the internal structure of the projection apparatus 100 in the present embodiment is provided.

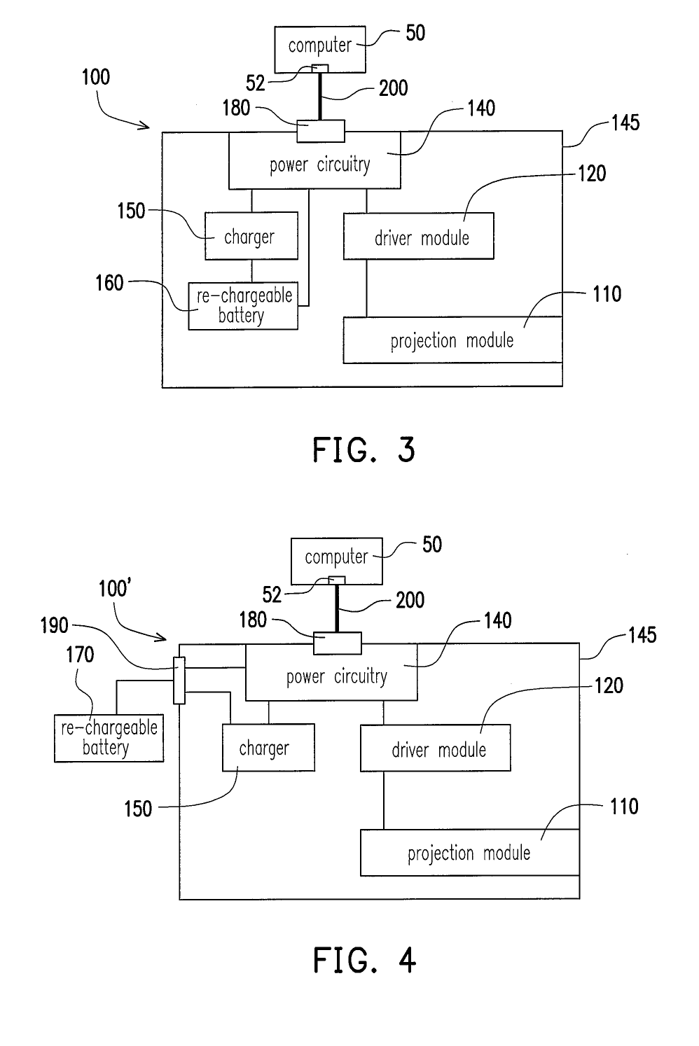

FIG. 3 is a block diagram showing the projection apparatus shown in FIG. 2. As shown in FIG. 3, the projection apparatus 100 in the present embodiment includes a projection module 110, a driver module 120, a power circuitry 140 and a casing 145. The driver module 120 is electrically connected to the projection module 110 and the power circuitry 140 is electrically connected to the driver module 120. The projection module 110, the driver module 120 and the power circuitry 140 are disposed inside the casing 145.

In the foregoing projection apparatus 100, the power circuitry 140 has a first port 180. The casing 145 exposes a portion of the first port 180. The USB transmission cable 200 connects the USB port 52 of the computer 50 to the first port 180 so that the power required to operate the projection apparatus 100 is transmitted from the computer 50 to the power circuitry 140 of the projection apparatus 100. Furthermore, according to the image signals from the computer 50, the driver module 120 drives the projection module 110 to produce an image light beam that corresponds to the image signals. The image light beam is projected to display an image onto a screen. More specifically, the foregoing projection module 120 includes a light source (not shown), a light valve (not shown) and a projection lens (not shown). The light source is, for example, a light-emitting diode (LED), suitable for providing an illumination light beam. The light valve is, for example, a digital micro-mirror device (DMD) or a liquid crystal on silicon panel (LCOS panel) disposed on the transmission path of the illumination light beam. Hence, the illumination light beam is converted into an image light beam that corresponds to the image signals from the computer 50. The projection lens is also disposed on the transmission path of the image light beam to display the image onto the screen.

In one embodiment, the projection apparatus 100 further includes a charger 150 and a re-chargeable battery 160. The charger 150 is disposed inside the casing 145 and electrically connected to the power circuitry 140. The re-chargeable battery 160 is also disposed inside the casing 145 and electrically connected to the charger 150 and the power circuitry 140. When the re-chargeable battery 160 has enough power, the power required by the power circuitry 140 is drawn from the re-chargeable battery 160 through an electric cable linking the re-chargeable battery 160 and the power circuitry 140. In other words, when the re-chargeable battery is sufficiently charged, the re-chargeable battery 160 provides the required power by the power circuitry 140 without having to electrically connect the power circuitry 140 to the USB port 52 of the computer 50.

When the power stored in the re-chargeable battery 160 runs low, the USB transmission cable 200 electrically connects the first port 180 of the power circuitry 140 to the USB port 50 of the computer 50 so that the computer 50 provides power to the power circuitry 140. Meanwhile, the charger 150 charges up the re-chargeable battery 160.

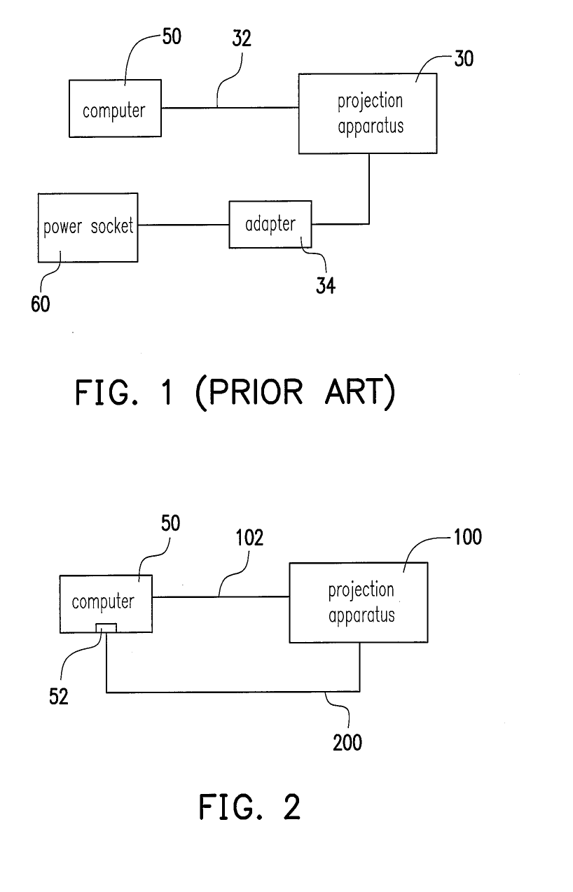

The computer 50 directly provides the power needed for operating the projection apparatus 100 in the present invention, there is no need to use an adapter. Therefore, the extra cost for producing the adapter is saved and the extra power consumed by the adapter is eliminated. In addition, the weight and volume of the USB transmission cable 200 is substantially smaller compared to an adapter so that it is lighter to carry and occupies less space. Moreover, the projection apparatus 200 also resolves the problem of the conventional projection apparatus 100 (shown in FIG. 1) not being able to operate in an outdoor environment or a place far from a power socket if the re-chargeable battery is low in power.

It should be noted that a multi-port USB transmission cable is used to increase the power per unit time provided by the computer 50 to the projection apparatus 100. One end of the USB transmission cable has a connector for connecting to the first port 180 of the power circuitry 140 and the other end has a plurality of connectors for simultaneously connecting to a number of USB ports of the computer 50.

FIG. 4 is a block diagram showing a projection apparatus according to another embodiment of the present invention. As shown in FIG. 4, the projection apparatus 100′ of the present embodiment is similar to the foregoing projection apparatus 100 (as shown in FIG. 3). Hence, the same elements in FIGS. 4 and 3 are labeled identically. In the following, only their differences are mentioned. The projection apparatus 100′ in the present embodiment further includes a second port 190 electrically connected to the power circuitry 140 and the charger 150. Furthermore, the casing 145 exposes a portion of the second port 190. In addition, the re-chargeable battery 170 is connected to projection apparatus 100′ outside the casing 145. The re-chargeable battery 170 is electrically connected to the power circuitry 140 and the charger 150 through the second port 190.

The re-chargeable battery 170 is connected to the projection apparatus 100′ of the present embodiment through the second port 190, the existing re-chargeable battery 170 is directly replaced by a fully-charged re-chargeable battery 170 when the power is low.

In summary, the projection apparatus in the present invention has at least the following advantages:

1. The power required to operate projection apparatus can be directly drawn from a computer without using an adapter. Hence, the production cost of the adapter is saved.

2. Compared with a conventional adapter, the USB transmission cable has a relatively smaller weight and occupies only a small volume. Therefore, it is easier and convenient for a user to carry the USB transmission cable around.

3. In one of the embodiments, the re-chargeable battery with low power is directly replaced with a freshly charged re-chargeable battery.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A projection apparatus suitable for electrically connecting to at least a universal serial bus (USB) port of a computer and receiving power required to operate the projection apparatus from the computer, comprising:
a projection module suitable for projecting an image light beam to display an image onto a screen;
a driver module electrically connected to the projection module, and being suitable for driving the projection module;
a power circuitry electrically connected to the driver module, wherein the power circuitry comprises a first port for electrically connecting to the USB port of the computer through a transmission cable; and
a casing for enclosing the projecting module, the driver module and the power circuitry but exposing a portion of the first port.

2. The projection apparatus of claim 1, further comprising:
a charger disposed inside the casing and electrically connected to the power circuitry; and
a re-chargeable battery disposed inside the casing and electrically connected to the charger and the power circuitry, when the power circuitry is electrically connected to the computer, the charger is adopted for charging the rechargeable battery, when the power circuitry is electrically insulated from the computer, the re-chargeable battery is adopted for providing power to the power circuitry.

3. The projection apparatus of claim 1, further comprising:
a charger disposed inside the casing and electrically connected to the power circuitry;
a second port electrically connected to the power circuitry and the charger but the casing exposing a portion of the second port; and
a re-chargeable battery disposed outside the casing suitable for electrically connecting to the charger and the power circuitry through the second port, when the power circuitry is electrically connected to the computer, the charger is adopted for charging the re-chargeable battery, when the power circuitry is electrically insulated from the computer, the re-chargeable battery is adopted for providing power to the power circuitry.

4. The projection apparatus of claim 1, wherein the projection module comprises:
a light source suitable for providing an illumination light beam;
a light valve disposed on the transmission path of the illumination light beam for converting the illumination light beam to the image light beam; and
a projection lens disposed on the transmission path of the image light beam for projecting the image light beam to display the image onto the screen.

5. The projection apparatus of claim 4, wherein the light source comprises a light-emitting diode.
